(19) United States
(12) Patent Application Publication
(10) Pub. No.: US 2005/0069638 A1
(43) Pub. Date: Mar. 31, 2005

(54) System for forming a gas flow of reactants for a doped glass material

(75) Inventors: Markku Rajala, Helsinki (FI); Kauko Janka, Tampere (FI); Simo Tammela, Espoo (FI); Taneli Tuurnala, Espoo (FI)

Correspondence Address: VENABLE, BAETJER, HOWARD AND CIVILETTI, LLP, P.O. BOX 34385, WASHINGTON, DC, 20043-9998, US

(73) Assignee: LIEKKI OY, LOHJA AS (FI)

(21) Appl. No.: 10/951,869

(22) Filed: Sep. 29, 2004

(30) Foreign Application Priority Data
Sep. 29, 2003 (FI) 20031398

(51) Int. Cl. B05D 5/06

(52) U.S. Cl. 427/163.2

(57) ABSTRACT

A system and a method in producing a doped glass material, particularly a glass material to be used in light amplifying optical waveguides. The method comprising: bringing at least a first dopant and a second dopant of the glass material into a vaporous gas phase; controlling the vapour pressure of the gas phase of each dopant by bringing each dopant to a desired temperature which is simultaneously used to control the composition of their gas phase; and mixing each vaporous dopant with the gas flow of the basic material for the glass material, which basic material is also in a gas phase and is used as a carrier gas for the dopants, wherein said basic material and said dopants together constitute the required gas flow of so-called reactants, to be used for producing the glass material; performing the mixing so that said dopants are each mixed in turn with the same gas flow of the basic material in such an order that said desired temperatures of the dopants are increasing in relation to one another.

### FIELD OF THE INVENTION

The invention relates to a method in the production of a doped glass material, particularly a glass material to be used in light amplification optical waveguides. The invention also relates to a system in the production of a doped glass material, particularly a glass material to be used in light amplification optical waveguides.

### BACKGROUND OF THE INVENTION

An important use of doped glass materials is light amplification waveguides, for example active optical fibres, whose light amplifying properties are based on utilizing stimulated emission. In order to make stimulated emission possible, the glass material in the core of the active optical fiber, and possibly also in the cladding layer surrounding the core, is doped with dopants, which are rare earth metals, for example erbium. In addition to optical fibers, the doped glass materials can also be used in different kinds of optical planar waveguides.

The active optical fibers are produced by drawing glass into optical fiber from a fiber preform, which fiber preform can be made in several different ways. A commonly used method for producing a fiber preform is to deposit glass material around a mandrel, or a corresponding substrate arranged to rotate, by flame hydrolysis deposition, FHD. When the above-mentioned deposition is performed from the outer periphery of the fiber preform, the so-called OVD method (outer vapour deposition) is the term often used in this context. The FHD method is also applied in forming glass layers required in optical planar waveguides on a planar substrate.

In the FHD method, a hydrogen-oxygen flame is typically used as a thermal reactor, and the glass forming basic materials used in the production of the glass material, for example silicon or germanium tetrachloride, are typically delivered in a vaporous form to the burner and the flame. The dopants of the glass material, such as, for example, erbium, are carried to the burner and the flame along with a carrier gas, typically in the form of a vapour or aerosol droplets formed of a liquid containing the dopants by vaporizing or by spraying, respectively.

In the flame used as a thermal reactor in the FHD or liquid flame spraying method, the basic materials and dopants further form aerosol particles, which aerosol particles are guided onto the substrate to be coated, thus forming-a doped porous glass material coating. In prior art references in the English language, these aerosol particles are often referred to as “glass soot”. When a suitable coating layer of porous glass material has been deposited on the mandrel or other substrate, the above-mentioned coating layer is sintered to form dense glass by a heat treatment of the substrate at a suitable high temperature. A so-called solution doping method is also known, in which method a fiber preform deposited of mere basic materials is dipped into a solution containing dopants first after depositing the fiber preform, before sintering.

Rare earth metals dissolve poorly into quartz glass and require that, for example, the structure of SiO₂ based glass has been modified by admixing a suitable oxide with the glass. Oxides suitable for the purpose include, for example, Al₂O₃, La₂O₃, Yb₂O₃ or P₂O₅. Preferably, this oxide is aluminium oxide Al₂O₃, which at the same time increases the refractive index of the glass.

When the core of an optical fiber (or another waveguide) is doped with a rare earth metal, the aluminium oxide simultaneously provides an increase in the refractive index of the core in relation to the cladding layer, which is necessary for satisfying the operating principle of the optical fiber.

The capacity of liquids to discharge vapour into ambient air is represented by the vapour pressure of the substance, wherein the unit used is atm, kPa or mmHg. A liquid with a high vapour pressure is easily evaporated, and the vapour pressure of the substance will increase the higher, the warmer it is. Consequently, in a closed vessel and in a balanced state, saturated vapour will be formed above the liquid level, and the vapour concentration can be found out, for example, by calculating the concentration in a balanced situation. This concentration is dependent on the vapour pressure of the substance, wherein the concentration increases as the temperature rises. The concentration of the substance in vapour form in the air is normally given in parts per million (unit ppm). The composition of the carrier gas is thus changed in a way determined by the vapour pressure, which is known as such.

If the vapour is led from a heated vessel into a space or a pipe system which is cooler than the temperature of the vessel, the vapour will start to condense to a liquid, because the temperature is lower than the temperature of the saturated vapour. The condensation of the vapour into a liquid is not desirable in view of the management of the processes, because it has a direct effect on the vapour concentration and thereby on the mass flow of the substance conveyed with the carrier gas, and these parameters, in turn, are essential in view of the operation of the reactor. Problems occur particularly in cases in which separate flows of reactants or dopants are mixed, wherein the pipework in use is complex and simultaneously the temperature control becomes complicated.

One device of prior art, disclosed in U.S. Pat. No. 4,826,288, comprises several sources of a vapourous dopant. The means, in which the vapour is generated, are supplied with a carrier gas, and the outlets from all the sources are coupled together and led into a reactor. The temperature of each source as well as the temperature of the connecting pipes are controlled by a heating system according to prior art. The evaporating means, i.e. containers, are separate, each having a separate carrier gas inlet and outlet. For this reason, the control of the carrier gas and the dopants further requires a material feeding system, which is difficult to control, and a large number of valves, which must also be sufficiently heat resistant.

### SUMMARY OF THE INVENTION

It is the main aim of the present invention to present a completely new system for mixing basic materials and reactants, whereby the above-described problems present in the processes of prior art are avoided.

The basic principle of the invention is particularly to collect dopants into the same carrier gas flow, wherein the evaporating means are coupled in series. One basic principle is also that the dopants are collected in the order of increasing temperature requirement. The temperature requirement, in turn, will be determined by the vapour pressure and the desired content of the dopant.

Because the vapour generating containers are arranged in such a way that the vapour is always transferred into a space or into a container warmer than the starting point, it is possible to avoid the condensation of the vapour into liquid onto the inner surfaces of the containers or conduits. At the same time, one avoids a change in the composition of the carrier gas, caused by a decrease in the temperature and the vapour pressure. The pipes connecting the containers are also heated, but their temperatures are selected to be suitable so that the temperature is higher than that in the preceding container and lower than (or equal to) the temperature in the next container. Thanks to the invention, the material feeding system becomes considerably simpler, the condensation is avoided, and the control of temperatures becomes easier. The composition of the carrier gas is now controlled primarily by controlling the temperature and not by using valves.

### DESCRIPTION OF THE DRAWINGS

In the following, the invention and some of its advantageous embodiments will be described in more detail with reference to the appended drawings, in which

FIG. 1 shows a system applying one embodiment of the invention,

FIG. 2 illustrates the interdependence between the vapour pressure and the temperature for some substances,

FIG. 3 shows the structure and operation of a thermal reactor.

### DETAILED DESCRIPTION OF THE INVENTION

All the reactants required for the production of doped glass material according to the invention, as well as the basicmaterials (for example Si or Ge compounds) and dopants (for example Al compounds and compounds of rare earth metals) are first brought to a vaporous form, i.e. the gas phase, by suitably raising the temperature of said materials and by selecting a suitable chemical composition for each reactant. Technically, the heating of the containers of the reactants can be implemented by methods known as such. For the glass material, for example silicon tetrachloride SiCl₄ is used as the basic material and aluminium and erbium as the dopants, the latter ones in the form of either nitrates or chlorides. The compounds used as the sources of aluminium and erbium are, for example, dissolved in suitable liquids and evaporated further to a gas phase by heating the solutions. Suitable carrier gases are utilized for carrying the reactants brought to the gas phase.

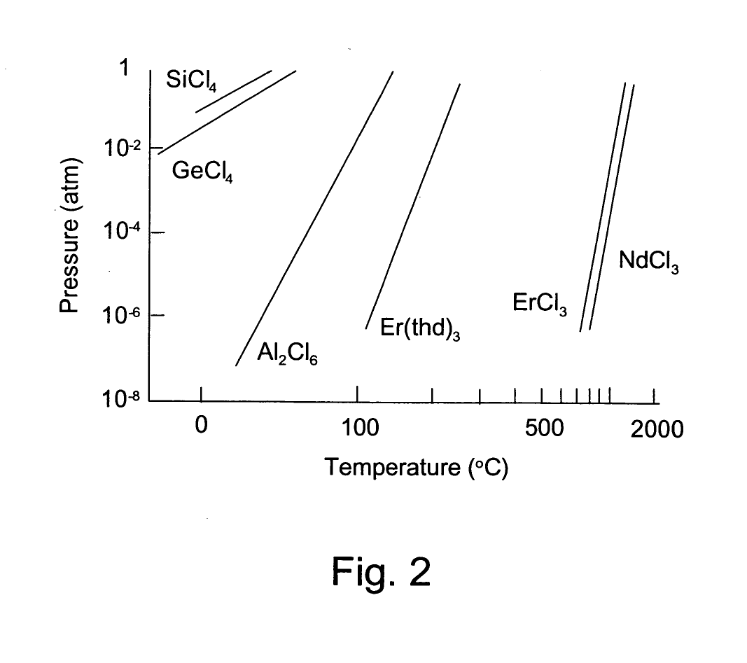

The basic materials and the dopants, which are in a gaseous and reduced form and are mixed with each other, are then guided as gas flows into a reactor, and the temperature is simultaneously kept at such a level that the basic materials and the dopants remain in their vapour form. FIG. 2 shows, as examples, some halides used for producing a doped glass material. As shown in FIG. 2, the vapour pressure (unit atm) increases with the temperature (unit ° C.).

According to prior art, the basic materials and the dopants are kept separate from each other, and their mutual ratio can be adjusted, if necessary, by changing the mutual ratio between the gas flows by means of, for example, control valves, such as mass flow controllers, or in another suitable way. In the present invention, at least a part of the basic materials and the dopants are mixed into the same gas flow, but it is also possible to mix other dopants according to prior art, for example by means of control valves. The carrier gas can also be formed by combining separate gas flows. Gases with the function of reaction control are also supplied in separate flows via separate conduits into the reactor.

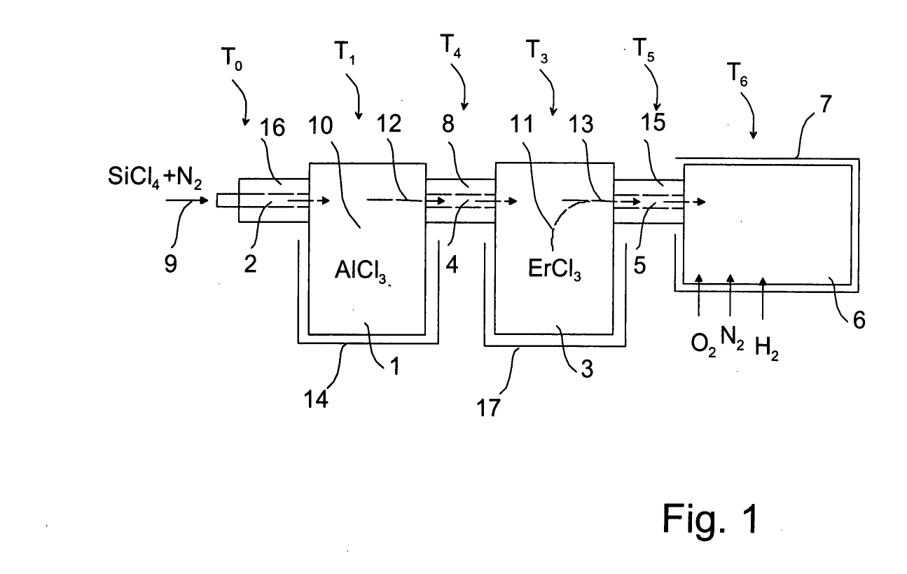

In the embodiment of FIG. 1, a doped glass material is made to be used particularly in light amplifying optical waveguides. According to one embodiment of the invention, the carrier gas 9 is a mixture of silicon tetrachloride SiCl₄ and nitrogen N₂ (or a mixture of silicon tetrachloride SiCl₄ and oxygen O₂), which is led via a pipeline or conduit 2 into a first container 1. The container 1 is heated to a temperature T₁, wherein the dopant 10 in the container 1, for example aluminium chloride AICl₃, has a vapour pressure p₁ determined by the temperature T₁ in the gas space of the container 1. The composition of the carrier gas 9 is changed in a way determined by the vapour pressure, which is known as such. The carrier gas 9 with the dopant 10, i.e. the gas mixture 12, is further led directly to the next container 3 via a conduit 4. The container 3 is heated to a temperature T₃ which is higher than T₁. The. conduit 4, in turn, is heated to a temperature T₄ which is lower than T₃ but higher than T₁ to avoid the condensation of the vaporous gas mixture 12 onto the inner surface of the conduit 4. The different conduits are heated, for example, by heating elements 8 and 15 placed around the respective conduits. Also, the heating of the different containers is arranged, for example, with heating elements 14 and 17 placed around the respective containers. If necessary, the conduit 2 is also enveloped in a heating element 16 to keep the gas mixture at a correct temperature T₂ which is preferably lower than the temperature T₁.

Each conduit and container comprises a separate controlled heating system which is controlled, for example, centrally by a control system. The operation of the system is normally also provided with temperature sensors to provide information about the temperature. Moreover, the control of the supply of the carrier gas can also be provided with a control valve and the necessary sensor means for receiving information about the carrier gas flow. In the system of the invention, it is possible to apply measuring and sensor systems known as such.

From the conduit 4, the gas mixture 12 is led into a container 3 of a dopant 11 which is, in this case, erbium chloride ErCl₃. The composition of the carrier gas, i.e. the gas mixture 12, is changed again in a way determined by the vapour pressure of the dopant 11, resulting in a gas mixture 13. From the container 3, the gas mixture 13 is led into a conduit 5. The conduit 5, in turn, is heated to a temperature T₅ which is higher than T₃ to avoid the condensation of the vaporous gas mixture 13 onto the inner surface of the conduit 5. The temperature T₃, in turn, is higher than T₁, to avoid the condensation of the vaporous gas mixture 12 inside the container 3 and the change in the composition of the carrier gas 12 with respect to erbium chloride ErCl₃.

Along the conduit 5, the gas mixture which forms the gas flow 13 of reactants to be supplied into the reactor 6 is, in turn, led into an oven-like reactor 6 in which is it processed in a way known as such. If necessary, along separate conduits, the reactor 6 is also supplied with oxygen O₂, an inert gas, such as nitrogen N₂, and hydrogen H₂, whose use will depend on the thermal reactor and on the method, and whose purpose is to control the reactions. The reactor 6, in turn, is heated e.g. by means of an induction coil 7 to a temperature T₆ which is higher than T₅ and which is preferably also higher than the temperature required by the reactor process. The carrier gas, the dopants and the auxiliary gases react in the reactor 6 in a way known as such, to produce a fibre preform.

In the reactor, the hot and mixed gases/vapours in reduced form in the gas flow are oxidized and condensed to oxides to form the glass material. The method of oxidation will depend on the intended final result. In particular when homogeneity is aimed at, the oxidation/condensation is performed at such a temperature and under such gas conditions that all the reactants achieve a state of multiple supersaturation (oven temperature from 1000 to 2000° C.). As a result, the quick condensation of all the constituents produces droplets and immediately further glass particles with a homogeneous reciprocal and internal composition. The quick condensation is triggered, for example, by quick oxidation of the reactants and/or by quick adiabatic expansion of the gas flow of the reactants. The quick oxidation, in turn, is achieved by strong jets of the oxidizing gas (O₂).

When producing doped glass materials, the basic materials used can also be chlorine-free reactants, such as TEOS (tetraethylortosilicate) or GEOS (tetraethoxygermanium) in a suitable form. In addition to the dopants mentioned above, it is also possible to use other rare earth metals and lantanides, such as, for example, neodymium, and further also phosphorus, borium and/or fluorine.

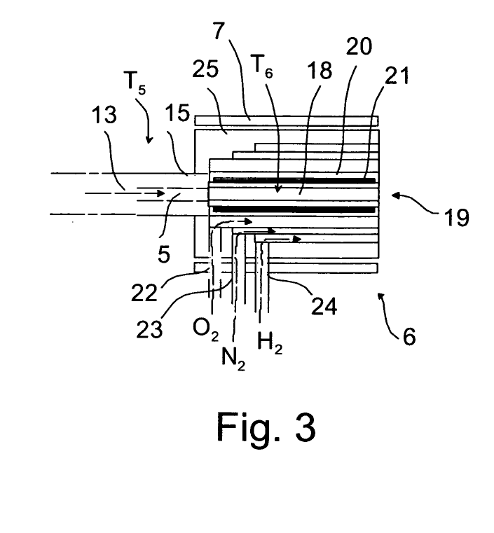

We shall now discuss in more detail one embodiment of the invention in which the reactor 6 is an OVD burner. The OVD burner is shown in a reduced cross-sectional view in FIG. 3, and it is, in principle, a cylindrical gas burner with at least one conduit. The conduits are constructed by means of quartz glass tubes within each other. As shown in FIG. 3, the conduit 5 is extended by a conduit 18 through the reactor 6, and the gas mixture 13 is discharged from a burner nozzle 19. The conduit 18 is enveloped by a shield 20 made of, for example, quartz glass. Furthermore, a heating element, i.e. a heating cylinder 21, which is made of, for example, graphite, is provided inside the shield 20 in the oven chamber and around the conduit 18. The heating element 21 can also be placed inside the conduit 18. The heating cylinder 21 and simultaneously the conduit 18 is heated by the effect of the heating element 7 to a temperature T₆ which is higher than the temperature T₅. The heating element 7 is normally an induction coil comprising a power source. The reactor 6 is enveloped in a thermal insulator 25.

The burner 6 is supplied with oxygen O₂ for the combustion and a fuel gas, for example nitrogen H₂, via gas inlets 22 and 24, respectively. An inert gas, for example nitrogen N₂, is supplied via a gas inlet 23 to prevent the mixing of the fuel gas and the oxygen O₂ on the surface of the burner 6. The fuel gas and the oxygen O₂ react outside the burner 6, and the mixture is ignited by, for example, and electric spark. The reactants supplied from the conduit 18 react in a flame and form glass particles which can be further collected, for example by thermophoresis, onto the surface of the first mandrel used for the manufacture of the fibre preform.

In one embodiment, the reactor 6 also comprises two quartz glass tubes forming the conduit 18 and the shield 20 shown in FIG. 3. The reactor also comprises a heating cylinder 21 heated by means of a heating element 7, as well as an insulator 18. However, the gas inlets 22, 23 and 24 lead directly into the conduit 18.

The invention is not limited solely to the above-presented embodiments, but it can be varied within the scope of the appended claims.

1. A method in producing a doped glass material, particularly a glass material used in light amplifying optical waveguides, the method comprising:
bringing at least a first dopant and a second dopant of the glass material into a vaporous gas phase,
controlling the vapour pressure of the gas phase of each dopant by bringing each dopant to a desired temperature which is simultaneously used to control the composition of their gas phase, and
mixing each vaporous dopant, each in turn, into the same gas flow of the basic material of the glass material in such an order that said desired temperatures of the dopants are mutually increasing, wherein the basic material is also in a gas phase and is used as a carrier gas for the dopants, and wherein said basic material and said dopants together constitute the required gas flow of so-called reactants, to be used for producing the glass material.

2. The method according to claim 1, the method comprising:
forming the gas phase of the dopants in at least a first container and a second container,
leading the carrier gas into the first container, in which it is allowed to be mixed with the first dopant, and
leading the gas mixture of the carrier gas and the first dopant from the first container into the second container, in which they are allowed to be mixed with the second dopant, and
discharging the gas mixture of the carrier gas, the first dopant and the second dopant from the second container.

3. The method according to claim 2, wherein the temperature of each container is lower than the temperature of the next containers.

4. The method according to claim 2, the method comprising:
leading the gas mixture between the containers via a conduit whose temperature is higher than that of the container, from which said gas flow enters said conduit, and whose temperature is lower than that of the container to which said gas flow is transferred from said conduit.

5. The method according to claim 3, the method comprising:
leading the gas mixture between the containers via a conduit whose temperature is higher -than that of the container, from which said gas flow enters said conduit, and whose temperature is lower than that of the container to which said gas flow is transferred from said conduit.

6. The method according to claim 1, the method comprising:
leading the gas flow of the reactants into a thermal reactor, and
keeping said reactor at a temperature higher than said desired temperatures.

7. The method according to claim 2, the method comprising:
leading the gas flow of the reactants into a thermal reactor, and
keeping said reactor at a temperature higher than said desired temperatures.

8. The method according to claim 7, the method comprising:
leading the gas mixture from the second container into the thermal reactor, in which the temperature is higher than the temperature of the second container.

9. The method according to claim 4, the method comprising:
leading the gas flow of the reactants into a thermal reactor, and
keeping said reactor at a temperature higher than said desired temperatures.

10. The method according to claim 7, the method comprising:
leading the gas mixture between the second container and the reactor via a conduit whose temperature is higher than that of the second container, from which the gas flow enters the conduit and whose temperature is lower than that of the reactor.

11. The method according to claim 8, the method comprising:
leading the gas mixture between the second container and the reactor via a conduit whose temperature is higher than that of the second container, from which the gas flow enters the conduit and whose temperature is lower than that of the reactor.

12. The method according to claim 6, the method comprising:
bringing the gas mixture in the reactor to a temperature, at which a state of multiple supersaturation of said gas mixture is achieved, and oxidizing the gas mixture as quickly as possible, simultaneously causing condensation and further the formation of homogeneous glass material particles.

13. The method according to claim 1, wherein the basic material for the glass material is an inorganic compound of silicon, an inorganic compound of germanium, an organic compound of silicon, an organic compound of germanium, silicon tetrachloride, germanium tetrachloride, TEOS (tetraethylortoilicate), or GEOS (tetraethoxygermanium).

14. The method according to claim 1, wherein the dopant in the glass material is erbium, neodymium, a rare earth metal, aluminium, phosphorus, borium, or fluorine.

15. The method according to claim 13, wherein the dopant in the glass material is erbium, neodymium, a rare earth metal, aluminium, phosphorus, borium, or fluorine.

16. A system in producing a doped glass material, particularly a glass material to be used in light amplifying optical waveguides, the system comprising:
first means for bringing at least a first dopant and a second dopant for the glass material into a vaporous gas phase, wherein the first means are arranged for controlling the vapour pressure of the gas phase of each dopant by bringing each dopant to a desired temperature, which is simultaneously used to control the composition of their gas phase, and
second means for mixing each vaporous dopant into the gas flow of the basic material for the glass material, which basic material is also in a gas phase and is used as a carrier gas for the dopants, wherein said basic material and said dopants together constitute the required gas flow of so-called reactants, to be used for producing the glass material,
wherein the first and second means are arranged in such an order in which said dopants are, each in turn, mixed with the same gas flow of the basic material, and in which said desired temperatures of the dopants are increasing in relation to one another.

17. The system according to claim 16, wherein the first means comprise a set of containers coupled in series, and wherein the temperature of each container is lower than the temperature of the next containers.

18. The system according to claim 17, wherein the second means comprise at least one conduit fitted between the containers to lead a gas mixture between the containers, and wherein the temperature of the conduit is higher than that of the container, from which said gas flow enters said conduit, but lower than that of the container, to which said gas flow is transferred from said conduit.

19. The system according to claim 18, wherein the system further comprises a thermal reactor, and wherein the second means comprise at least one conduit, by means of which the ready gas mixture of the reactants is led to a reactor and whose temperature is higher than that of the container, from which the gas flow enters the conduit, and lower than that of the reactor.

20. The system according to claim 19, wherein the thermal reactor is made of at least two quartz glass tubes within each other, and wherein at least the innermost quartz glass tube is enveloped in a heating element which is made of graphite and which is heated by induction.
